(19) United States
(12) Patent Application Publication
(10) Pub. No.: US 2026/0280247 A1
(43) Pub. Date: Sep. 17, 2026

(54) BUS DUCT FOR DIRECT CURRENT POWER BRANCHING AND DIRECT CURRENT POWER BUS DUCT SYSTEM COMPRISING SAME

(71) Applicant: LS CABLE & SYSTEM LTD., Anyang-si, Gyeonggi-do (KR)

(72) Inventors: Bong Suk KIM, Suwon-si, Gyeonggi-do (KR); Min Woo LEE, Anyang-si, Gyeonggi-do (KR); Dong Eun LEE, Bucheon-si, Gyeonggi-do (KR); Geun Young JEONG, Buk-gu, Daegu (KR)

(21) Appl. No.: 19/167,157

(22) PCT Filed: Mar. 28, 2024
(86) PCT No.: PCT/KR2024/003939

§ 371 Date: Sep. 19, 2025

(30) Foreign Application Priority Data
Mar. 28, 2023 (KR) 10-2023-0040225
Mar. 27, 2024 (KR) 10-2024-0041773

(51) Int. Cl. H02G 3/04; H02G 5/06

(52) U.S. Cl. CPC H02G 3/0462; H02G 5/061

(57) ABSTRACT

The present disclosure relates to a bus duct for direct current power branching and a bus duct system comprising the same, which can minimize arcs and safety hazard that may occur in a process of installation and removal of a branch box in the bus duct for direct current power branching.

### CROSS-REFERENCE TO RELATED APPLICATIONS

The present application is a National Stage of International Application No. PCT/KR2024/003939, filed on Mar. 28, 2024, which claims priority to Korean Application No. 10-2023-0040225, filed Mar. 28, 2023, and Korean Application No. 10-2024-0041773, filed Mar. 27, 2024, the entire contents of each hereby incorporated by reference.

### FIELD

The present disclosure relates to a bus duct for direct current power branching and a bus duct system comprising the same. More specifically, the present disclosure relates to a bus duct for direct current power branching and a bus duct system comprising the same, which can minimize arcs and safety hazard that may occur in a process of installation and removal of a branch box in the bus duct for direct current power branching.

### BACKGROUND

The bus duct system replacing a cable has been rapidly increasing in use due to advantages such as large-capacity current transmission, efficient space utilization, construction convenience, and power quality stability.

Furthermore, as the use of direct current power-based digital devices and load rapidly increases, energy efficiency is improved, and new renewable energy sources and distributed power sources are expanded, demand for bus ducts for DC power supply in data centers, communication towers, green/smart buildings, and the like is also increasing together.

A branching bus duct (Ph-Feeder) constituting a bus duct power system has a basic structure the same as a general bus duct (Feeder) but has a plug-in part for branching, and when a branch box (PH Box) is mounted, a tap conductor that may draw current by being connected to a contactor of the branch box is bonded to each pole bus bar.

In an existing alternating current bus duct system, since current polarity periodically changes over time, when a branch box is installed and removed to a bus duct in a live-wire state, magnitude of current repeatedly reaches a zero point, and even if an arc occurs, the arc may be easily extinguished, and thus occurrence of the arc is not greatly problematic.

However, in a direct current bus duct system, since direct current polarity does not change over time, when a branch box is installed and removed to a bus duct in a live-wire state, when a contact point between conductors makes contact or is separated, an arc jumping between contact points may occur, and in the case of direct current, since current does not reach to a zero point and is maintained, when the arc occurs, the arc is difficult to extinguish, and risk of electrical fire occurrence is great.

### SUMMARY

The present disclosure has as an object to provide a bus duct for direct current power branching and a bus duct system comprising the same, which can minimize arcs and safety hazard that may occur in a process of installation and removal of a branch box in the bus duct for direct current power branching.

To solve the aforementioned object, the present disclosure is directed to providing a bus duct for direct current power branching on which a branch box for power branching may be mounted. The bus duct for direct current power branching may comprise: a pair of busbars including a conductor; an enclosure accommodating the pair of busbars; and a pair of tap conductors, each of which includes a conductor portion and an insulation portion, wherein the conductor portion is exposed through an opening formed by partially opening the enclosure, so that a contactor provided in the branch box is detachably connected, and the insulation portion is provided at an end of the conductor portion and is formed of an insulation material.

In addition, the pair of bus bars may be each covered with an insulator and be accommodated inside the enclosure in a stacked state.

In this case, a height of the insulation portion in the tap conductor may be 5% to 30% of a total height of the tap conductor.

Further, a thickness of the insulation portion may be 0.05 mm to 5 mm.

Here, the pair of tap conductors may be respectively bonded to different positions based on a longitudinal direction of the pair of busbars.

In addition, the insulation portion may be mounted in an insulation cap form in a longitudinal direction of an end of the conductor portion of the tap conductor.

In this case, a locking groove may be provided in the conductor portion of the tap conductor, and a locking protrusion may be provided on an inner side of the insulation cap, so that separation of the insulation cap may be prevented when the insulation cap is mounted.

Further, a cross section of the insulation cap may be configured in a II-shape, the locking protrusion may be provided on the inner side of the insulation cap, and the locking groove may be configured by a method of forming a region in which a width based on a cross section of the tap conductor is reduced.

Here, the insulation portion may be provided in an entire region of the tap conductor along a longitudinal direction of the bus duct.

In addition, the insulation portion may be configured in a covering layer or coating layer form.

In this case, in order to prevent occurrence of a step in a boundary region of outer circumferential surfaces of the insulation portion and the tap conductor, a thickness of the tap conductor may be reduced in a region where the insulation portion is provided.

Further, a tap conductor frame supporting a periphery of the tap conductors exposed through the opening may be provided around the opening of the enclosure.

In addition, to solve the aforementioned object, the present disclosure is directed to providing a direct current power bus duct system, comprising: the above-described bus duct for direct current power branching; and a branch box mounted to the enclosure of the bus duct for direct current power branching, the branch box including a pair of contactors respectively electrically connected to the pair of tap conductors.

Here, the direct current power bus duct system may further comprise: at least one direct current power bus duct configured by including a pair of busbars each formed of a conductor and an insulator surrounding an outer circumferential surface of the conductor, and an enclosure accommodating the pair of busbars, and connected to the bus duct for direct current power branching; and at least one connection kit configured to connect the bus duct for direct current power branching and the direct current power bus duct.

### BRIEF DESCRIPTION OF THE DRAWINGS

FIG. 1 illustrates a perspective view of a direct current power bus duct system to which a bus duct for direct current power branching according to the present disclosure is applied.

FIG. 2 illustrates an exploded perspective view of the direct current power bus duct system according to the present disclosure.

FIG. 3 illustrates a cross-sectional view of the direct current power bus duct of the present disclosure.

FIG. 4 illustrates a cross-sectional view in the vicinity of a plug-in part of the bus duct for direct current power branching according to the present disclosure.

FIG. 5 illustrates a change in a contact state of a tap conductor and a contactor in a process in which a branch box is mounted or separated in the bus duct for direct current power branching according to the present disclosure.

FIG. 6 illustrates cross-sectional views of various embodiments of the tap conductor according to the present disclosure.

### DETAILED DESCRIPTION

Hereinafter, exemplary embodiments of the present disclosure will be described in detail with reference to the accompanying drawings. However, the present disclosure is not limited to the exemplary embodiments to be described below and may be specified as other aspects. On the contrary, the embodiments introduced herein are provided to make the disclosed content thorough and complete, and sufficiently transfer the technical teachings of the present disclosure to those skilled in the art. Like reference numerals indicate like constituent elements throughout the specification.

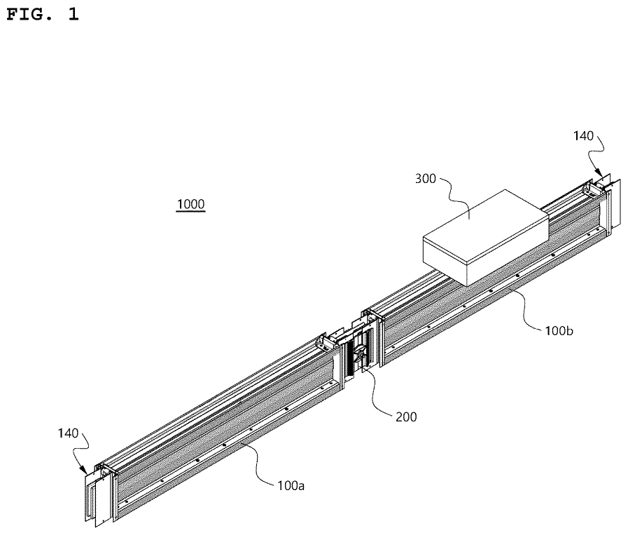

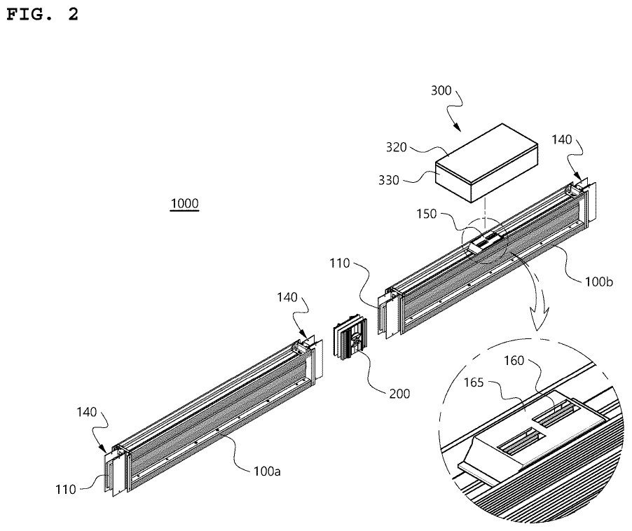

FIG. 1 illustrates a perspective view of a direct current power bus duct system 1000 to which a bus duct for direct current power branching according to the present disclosure is applied, and FIG. 2 illustrates a perspective view of a separated state of the direct current power bus duct system 1000 according to the present disclosure.

The direct current power bus duct system 1000 according to the present disclosure may be configured to include at least one connection kit 200.

The bus duct according to the present disclosure may be configured in a unit standard length by including a pair of busbars 110 including a conductor 111 for direct current power supply and an insulator 113 surrounding an outer circumferential surface of the conductor, and including an enclosure 120 accommodating the pair of busbars 110, and a connect part 140 for connection such as the connection kit 200 may be provided at both ends.

An embodiment illustrated in FIG. 1 and FIG. 2 illustrates a state in which one direct current power bus duct 100a and a bus duct 100b for direct current power branching are connected via the connection kit 200.

For power supply through the bus duct, a power branching device is required. As such a branching device, as illustrated in FIG. 1 and FIG. 2, a branch box 300 may be applied.

Such a branch box 300 may be connected with a general power cable or the like so as to deliver power transmitted through the bus duct to the general power cable or the like and may be a so-called PH Box provided with a fuse or a switch.

The branch box 300 is not mounted on all bus ducts but is mounted on the bus duct 100b for direct current power branching provided with a plug-in part 150 in a region where branching is required. Specifically, the branch box 300 for power branching may be detachably mounted on the plug-in part 150 of the bus duct 100b for direct current power branching, and power may be branched by connecting a cable or the like to the branch box 300.

As illustrated in FIG. 2, the branch box 300 may include a housing 330 provided with a cover member 320, and the plug-in part 150 of the bus duct 100b at a position where the branch box 300 is mounted may be provided such that a tap conductor 160 bonded to the bus bar 110 is exposed to an inner side of a tap conductor frame 165.

The bus ducts 100a and 100b illustrated in FIG. 1 and FIG. 2 are illustrated as straight bus ducts, but, for example, a direction of a power line may also be changed by using a 7-shaped bent bus duct or a connection kit configured such that a bus bar inserting part is oriented orthogonally.

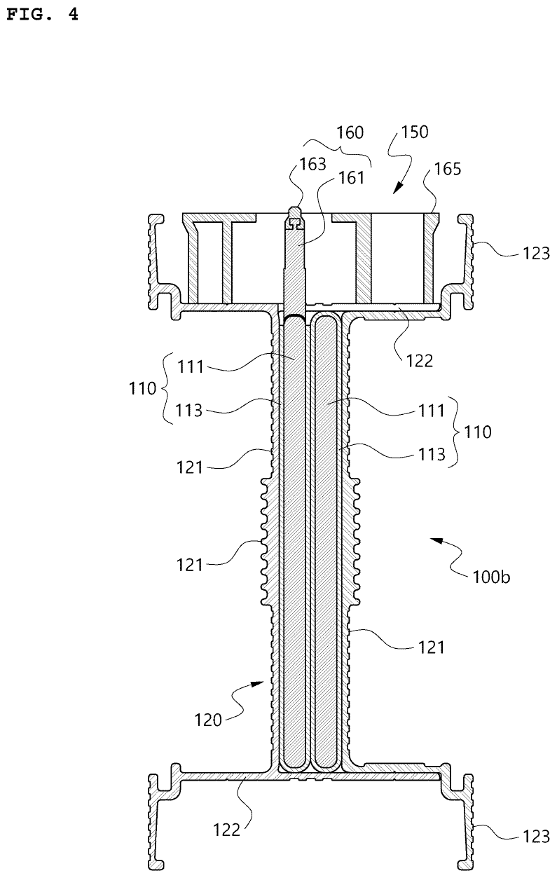

In the case of the bus duct in which the bus bars 110 are stacked in a sandwich type, the enclosure 120 may be provided on an upper portion, a lower portion, and both side surfaces to surround the stacked bus bars 110, and the enclosure 120 may be provided with flanges 122 and 123 (refer to FIG. 4). The branch box 300 may be mounted on the flange 122. The branch box 300 may be detachably mounted to the bus duct 100b with various shapes of fixing means (not illustrated).

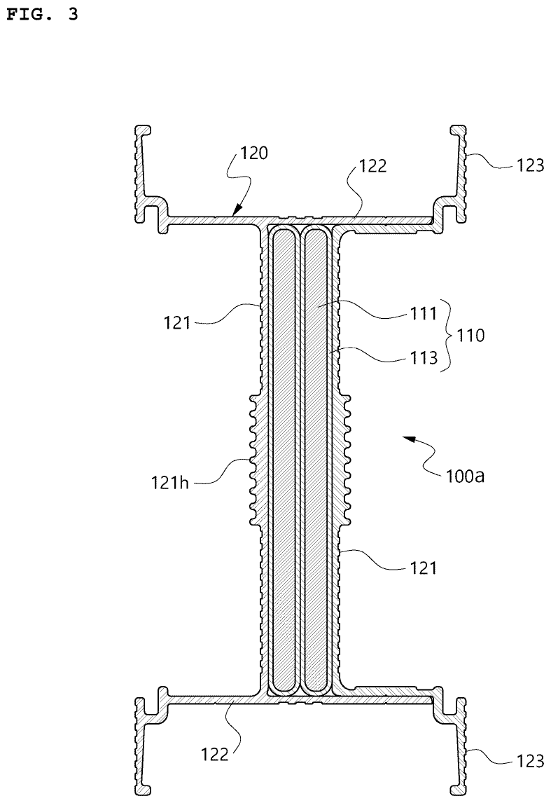

FIG. 3 illustrates a cross-sectional view of the direct current power bus duct 100a of the present disclosure, and FIG. 4 illustrates a cross-sectional view in the vicinity of the plug-in part 150 of the bus duct 100b for direct current power branching according to the present disclosure.

The direct current power bus duct 100a illustrated in FIG. 3 may be configured to include a pair of bus bars 110 stacked in parallel and an enclosure 120 accommodating the bus bars 110, and a connect part 140 (refer to FIG. 1 and FIG. 2) formed in a state in which the bus bars 110 are spread apart so that the conductor 111 is exposed, may be configured at least one longitudinal end of the enclosure 120 in order to be connected to the connection kit 200 (refer to FIG. 1 and FIG. 2) connecting one bus duct to another bus duct.

The bus bar 110 may be formed of the conductor 111 such as copper or aluminum having a length longer than a width. A surface of the conductor 111 is covered with the insulator 113 such as epoxy coating so as to be electrically insulated from each other. The bus bar 110, since a high current flows therein, is primarily insulated by covering with the insulator 113, and is accommodated inside the enclosure 120 in a state isolated from the outside to be protected.

In the case of a bus duct for alternating current power supply, the configuration of the bus bar 110 may be variously configured into, for example, three (R, S, T phases) to five (R, S, T, N, N phases) according to an installation object, an installation environment, and a supplied power capacity of the bus duct system 1000, but in the case of direct current, the bus duct may be configured with an even number of bus bars 110, such as two or four, distinguished into positive and negative poles.

As illustrated in FIG. 4, the pair of busbars 110 configured according to an embodiment of the present disclosure may be accommodated in the enclosure 120.

The enclosure 120 may be formed of a metallic material, may protect the bus bar 110, may provide a heat-dissipation function, and may be formed of aluminum or aluminum alloy material so as to be capable of extrusion or the like.

The enclosure 120 may be configured with an outer surface part 121 surrounding an upper surface or a lower surface of the stacked pair of busbars 110 and flange parts 122 and 123 surrounding both side ends of the bus bar 110 and may accommodate the stacked bus bar 110 by being manufactured in a manner of assembling a plurality of plates. In addition, the outer surface part 121 may be provided with a heat-dissipation structure 121h so as to improve heat-dissipation performance.

In addition, a basic structure of the bus duct 100b for direct current power branching according to the present disclosure illustrated in FIG. 4 is the same as the direct current power bus duct 100a illustrated in FIG. 3 but differs in that the plug-in part 150 is provided.

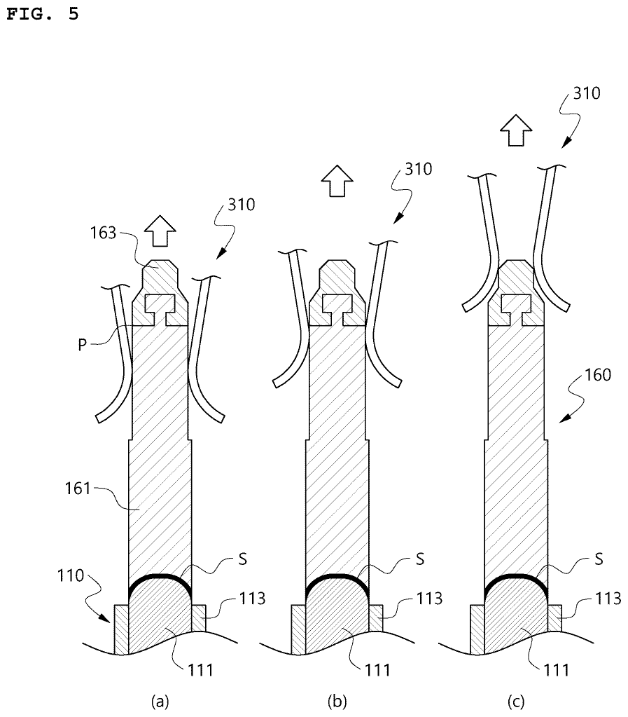

In addition, the bus duct 100b for direct current power branching according to the present disclosure is a bus duct for direct current power branching on which a branch box for power branching may be mounted, and specifically, the bus duct 100b for direct current power branching according to the present disclosure may include: a pair of busbars 110 including a conductor 111; an enclosure 120 accommodating the pair of busbars 110; and a pair of tap conductors 160, each of which includes a conductor portion 161 and an insulation portion 163, wherein the conductor portion 161 is bonded to the conductor 111 of the pair of bus bars 110 and is exposed through an opening formed by partially opening the enclosure 120, so that a contactor (not illustrated, see FIG. 5) provided in the branch box may be detachably connected, and the insulation portion 163 is provided at an end of the conductor portion 161 and is formed of an insulation material.

The pair of bus bars 110 may be configured in a form in which each conductor 111 is covered with the insulator 113 and the conductors 111 are accommodated inside the enclosure 120 in a stacked state.

The plug-in part 150 may be configured by forming an opening in a flange region at an end side in a width direction of the bus bar 110 in the enclosure 120, removing the insulator 113 of the bus bar 110, then bonding the pair of tap conductors 160 respectively to the conductors of the pair of busbars 110, and installing the tap conductor frame 165 at the periphery of the tap conductor 160.

The tap conductor frame 165 may perform a function of supporting the branch box 300, electrically connecting the tap conductor 160 with a contactor 310 of the branch box 300, preventing contact between adjacent tap conductors 160, and providing spatial separation.

The pair of tap conductors 160 for direct current power branching according to the present disclosure may be respectively bonded to different positions in the longitudinal direction of the bus bar 110.

In addition, in an embodiment of the present disclosure, since the number of the bus bars 110 is two, and when the positions of the tap conductors 160 are disposed apart in the longitudinal direction of the bus bar, a contact space with the contactor 310 of the branch box 300 may not be insufficient, so that the tap conductor 160 of the direct current power bus duct may be configured in a non-bent form.

In addition, the bus duct 100b for direct current power branching according to the present disclosure has a feature in that the insulation portion 163 is provided at an end of the conductor portion 161 constituting the tap conductor 160.

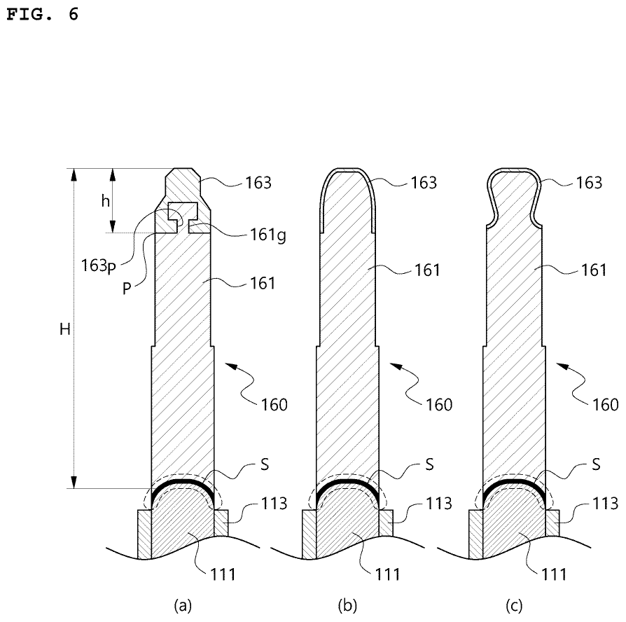

In an alternating current system, since a magnitude of current repeatedly reaches a zero point, even if an arc occurs, the arc may be easily extinguished, but in the case of a direct current system, when a contact point between conductors makes contact or is separated, an arc jumping between contact points may occur, and the present disclosure may provide the insulation portion 163 at an end of the conductor portion 161 constituting the tap conductor 160 so as to prevent occurrence of the arc between the tap conductor 160 and the contactor 310 of the branch box 300, thereby reducing such arc occurrence and preventing a safety accident. Hereinafter, with reference to FIG. 5 and FIG. 6, the insulation portion 163 provided in the tap conductor 160 will be described.

FIG. 5 illustrates a change in a contact state of the tap conductor 160 and the contactor 310 in a process in which a branch box is mounted or separated in the bus duct 100b for direct current power branching according to the present disclosure. Further, the contactor 310 provided in the branch box may be configured in a plate-shaped spring slot structure having elasticity.

The tap conductor 160 bonded to the bus bar 110 of the bus duct 100b for direct current power branching according to the present disclosure may be provided with the insulation portion 163 at an end of the tap conductor 160 so as to prevent or reduce arc occurrence that may occur in a process of separation or mounting of the branch box in the bus duct for power branching.

In a system using direct current power, a main cause of arc occurrence between conductors is a voltage difference or a rapid change of current occurring at a boundary portion of conductors at a time of separation and contact between conductors, and such voltage difference or rapid change of current between conductors may cause an arc due to electric discharge between the conductors being separated or contacted.

In order to prevent such arc occurrence, a method such as smoothing the shape of the conductor to be curved may also be possible, but since the contactor 310 of the branch box 300 may be configured in a plate-shaped spring slot structure having elasticity for stable electrical connection with the tap conductor 160, there is a limitation in changing the shape of the tap conductor 160.

Accordingly, the present disclosure prevents or minimizes arc occurrence by providing the insulation portion 163 at an end of the tap conductor 160 so that the insulation portion 163 is interposed at a time of contact or separation between the contactor 310 and the tap conductor 160.

A state illustrated in FIG. 5(a) illustrates a contact state of the conductor portion 161 of the tap conductor 160 and the contactor 310 at a point in time when rising starts so that the branch box is separated from the bus duct, and a state illustrated in FIG. 5(b) illustrates a state immediately before separation at a boundary point p of the conductor portion 161 of the tap conductor 160 and an inner circumferential surface of the contactor 310 in a rising process of the contactor 310, and a state illustrated in FIG. 5(c) illustrates a state in which separation of the contactor 310 and the conductor portion is completed in the rising process of the contactor 310.

As such, when the branch box is separated in a state in which the insulation portion 163 is provided at an end of the tap conductor 160, an inner circumferential surface of the contactor 310 maintains a sliding contact state along the conductor portion 161 of the tap conductor 160, but at the boundary point p of the conductor portion 161 and the insulation portion 163, an object with which the inner circumferential surface of the contactor 310 comes into contact is changed from the conductor portion 161 of the tap conductor 160 to the insulation portion 163 of the tap conductor 160, so that at the boundary point p where a voltage difference or a rapid change of current occurs between the conductor unit 161 of the tap conductor 160 and the contactor 310, the insulation unit 163 is interposed between the conductor unit 161 and the inner circumferential surface of the contactor 310 having the voltage difference, and electric charges concentrated at the boundary point p of the outer circumferential surfaces of the conductor portion 161 and the insulation portion 163 are dispersed, thereby preventing or minimizing arc occurrence.

Such arc occurrence prevention or reduction effect may be expected not only in a case where the branch box is separated from the bus duct, but also in a case where the branch box is mounted to the bus duct.

FIG. 6 illustrates cross-sectional views of various embodiments of the tap conductor 160 according to the present disclosure.

Specifically, an embodiment illustrated in FIG. 6(a) illustrates the tap conductor 160 illustrated in FIG. 5 in which the insulation portion 163 is configured in an insulation cap form, and FIG. 6(b) and FIG. 6(c) illustrate examples in which the insulation portion 163 is configured in a covering or coating layer form.

The insulation portion 163 of the tap conductor 160 provided in the bus bar 110 of the bus duct 100b for direct current power branching according to the present disclosure is not limited in form as long as it provides contactor insulation performance.

Accordingly, as illustrated in FIG. 6(a), the insulation portion 163 may be configured in an insulation cap form, and the insulation portion 163 in the insulation cap form may be provided such that a locking groove 161g is provided in the conductor portion 161 of the tap conductor 160, and a locking protrusion 163p is provided on an inner side of the insulation cap, so that separation of the insulation cap may be prevented in a mounting process or a separating process of the branch box 300 when the insulation cap is mounted.

In addition, as illustrated in FIG. 6(a), a cross section of the insulation cap is entirely configured in a II-shape, and the locking protrusion 163p is provided in a protrusion form projecting inward on the inner side of the insulation cap, and is locked and fixed in the locking groove 161g formed in the conductor portion 161 of the tap conductor 160, and may not be easily separated in a completed mounting state.

In addition, the locking groove 161g of the tap conductor 160 may be formed by a method of forming a region in which a width based on a cross section of the tap conductor 160 is reduced.

In addition, the insulation portion 163 may be configured not only in a method of being configured in the insulation cap form and mounted, but also in a method of coating or covering an end of the tap conductor 160, as illustrated in FIG. 6(b) and FIG. 6(c). When the insulation portion 163 is configured in a covering or coating form, there is an advantage in that restrictions on the shape of the end of the tap conductor 160 are lessened and cost may be reduced.

In addition, as illustrated in FIG. 6(b) and FIG. 6(c), even in a case where the insulation portion 163 is configured by a method such as covering or coating, in order to prevent occurrence of a step at the boundary point p of the conductor portion 161 and the insulation portion 163 on the outer circumferential surface of the tap conductor 160, the tap conductor 160 may be configured in a shape in which a thickness of the tap conductor 160 is reduced corresponding to a thickness of the insulation portion 163 in a region where the insulation portion 163 is provided, thereby solving a problem in which possibility of discharge due to electric field concentration at a protruding portion of the conductor is increased. Of course, as illustrated in FIG. 6(a), even in a case where the insulation portion 163 is configured in an insulation cap form, it is preferable to design a shape and thickness of the insulation cap so that no step occurs in a boundary region between the insulation cap and the conductor portion of the tap conductor, and the shape is flat.

Further, in the tap conductor 160, a height h of the insulation portion 163 is preferably configured to be about 5% to 30% of a total height H of the tap conductor 160.

When the height h of the insulation portion 163 is less than 5% of the total height H of the tap conductor 160, a problem occurs in that the insulation portion 163 is easily separated or deviated from the conductor portion 161 because a structure in which the insulation portion is stably fixed is not formed, or sufficient strength for covering or coating is not achieved, and when the height is greater than 30%, there is no difference in effect of preventing arc occurrence, and thus it was confirmed that it is unnecessary to be excessively large.

In addition, it is important to appropriately determine a thickness of the insulation portion 163, and when the thickness of the insulation portion 163 is too thin, insulation performance deteriorates, arc occurrence suppression performance may be degraded, and the insulation portion 163 may be easily damaged due to friction of the contactor. On the other hand, since the thickness of the insulation portion 163 does not need to be unnecessarily large, from this perspective, the thickness of the insulation portion 163 is preferably configured to be about 0.05 mm to 5 mm.

While the present specification has been described above with reference to the exemplary embodiments of the present disclosure, it may be understood by those skilled in the art that the present disclosure may be variously modified and changed without departing from the technical teachings and scope of the present disclosure disclosed in the claims. Therefore, it should be understood that any modified embodiment that essentially includes the constituent elements of the claims of the present disclosure is included in the technical scope of the present disclosure.

1. A bus duct for direct current power branching on which a branch box for power branching is mounted, comprising:
a pair of busbars including a conductor;
an enclosure accommodating the pair of busbars; and
a pair of tap conductors, each of which includes a conductor portion and an insulation portion,
wherein the conductor portion is exposed through an opening formed by partially opening the enclosure, so that a contactor provided in the branch box is detachably connected, and the insulation portion is provided at an end of the conductor portion and is formed of an insulation material.

2. The bus duct for direct current power branching of claim 1, wherein the pair of bus bars are each covered with an insulator and are accommodated inside the enclosure in a stacked state.

3. The bus duct for direct current power branching of claim 1, wherein a height of the insulation portion in the tap conductor is 5% to 30% of a total height of the tap conductor.

4. The bus duct for direct current power branching of claim 1, wherein a thickness of the insulation portion is 0.05 mm to 5 mm.

5. The bus duct for direct current power branching of claim 1, wherein the pair of tap conductors are respectively bonded to different positions based on a longitudinal direction of the pair of busbars.

6. The bus duct for direct current power branching of claim 1, wherein the insulation portion is mounted in an insulation cap form in a longitudinal direction of an end of the conductor portion of the tap conductor.

7. The bus duct for direct current power branching of claim 6, wherein a locking groove is provided in the conductor portion of the tap conductor, and a locking protrusion is provided on an inner side of the insulation cap, so that separation of the insulation cap is prevented when the insulation cap is mounted.

8. The bus duct for direct current power branching of claim 7, wherein a cross section of the insulation cap is configured in a II-shape, the locking protrusion is provided on the inner side of the insulation cap, and the locking groove is configured by a method of forming a region in which a width based on a cross section of the tap conductor is reduced.

9. The bus duct for direct current power branching of claim 1, wherein the insulation portion is provided in an entire region of the tap conductor along a longitudinal direction of the bus duct.

10. The bus duct for direct current power branching of claim 1, wherein the insulation portion is configured in a covering layer or coating layer form.

11. The bus duct for direct current power branching of claim 6, wherein in order to prevent occurrence of a step in a boundary region of outer circumferential surfaces of the insulation portion and the tap conductor, a thickness of the tap conductor is reduced in a region where the insulation portion is provided.

12. The bus duct for direct current power branching of claim 10, wherein in order to prevent occurrence of a step in a boundary region of outer circumferential surfaces of the insulation portion and the tap conductor, a thickness of the tap conductor is reduced in a region where the insulation portion is provided.

13. The bus duct for direct current power branching of claim 1, wherein a tap conductor frame supporting a periphery of the tap conductors exposed through the opening is provided around the opening of the enclosure.

14. A direct current power bus duct system, comprising:
the bus duct for direct current power branching according to any one of claims 1; and
a branch box mounted to the enclosure of the bus duct for direct current power branching, the branch box including a pair of contactors respectively electrically connected to the pair of tap conductors.

15. The direct current power bus duct system of claim 14, further comprising:
at least one direct current power bus duct configured by including a pair of busbars each formed of a conductor and an insulator surrounding an outer circumferential surface of the conductor, and an enclosure accommodating the pair of busbars, and connected to the bus duct for direct current power branching; and
at least one connection kit configured to connect the bus duct for direct current power branching and the direct current power bus duct.
